(19) United States
(12) Patent Application Publication
(10) Pub. No.: US 2015/0363061 A1
(43) Pub. Date: Dec. 17, 2015

(54) SYSTEM AND METHOD FOR PROVIDING RELATED DIGITAL CONTENT

(71) Applicant: AUTONOMIC CONTROLS, INC., Armonk, NY (US)

(72) Inventors: Michael de Nigris, III, Armonk, NY (US); Michael Toscano, North Salem, NY (US); Michael de Nigris, Armonk, NY (US)

(21) Appl. No.: 14/732,946

(22) Filed: Jun. 8, 2015

Related U.S. Application Data
(60) Provisional application No. 62/011,811, filed on Jun. 13, 2014.

(51) Int. Cl. G06F 3/0484; G06F 3/0482

(52) U.S. Cl. CPC G06F 3/0484; G06F 3/0482

(57) ABSTRACT

The present invention relates to an automated system and algorithm that aids in the automatic discovery and presentation of media content, in particular, music content, that is available across multiple online music services. More specifically, the disclosed embodiments utilize the meta-data associated with a given media content item (seed content) being accessed to find related or similar content, radio stations, or music streams and the like from across multiple online music services (such as iTunes, Rhapsody, Spotify, Pandora, etc.). The system then selects, arranges and presents those actions and/or media content items to a user in a blended list of actionable links. Selection can include comparing and ranking of available media content items or sources according to one or more selection criteria concerning one or more of the following attributes: cost, quality, availability and speed of access of the particular media content.

### CROSS-REFERENCE TO RELATED APPLICATIONS

The present application claims priority to U.S. Patent Application Ser. No. 62/011,811, entitled “SYSTEM AND METHOD FOR PROVIDING RELATED DIGITAL CONTENT” filed Jun. 13, 2014, the entire contents of which is incorporated by reference as if set forth in its entirety herein.

### TECHNICAL FIELD OF THE INVENTION

The present invention relates to systems and methods for providing media content, in particular, systems and methods for identifying, presenting and providing access to related media content.

### BACKGROUND OF THE INVENTION

There exists systems for providing media content, for example, online music services that maintain music libraries, radio stations, or music streams that are accessible by users. Examples of these types of content providers and services include iTunes, Rhapsody, Spotify, Pandora, and the like. These media content and service providers provide a variety of types of content in various formats including text, digital sound, digital video and the like.

The various online media content and service providers can be accessed using personal computing devices, such as, media servers, PCs, laptops, tablets and smart phones. These personal computing devices and other electronic devices are also capable of playing media content stored on one or more local or networked storage devices. However, in order for a user to view, browse and consume media content from these disparate and independent sources, the user must use dedicated programs and portals. Independently interacting with the various portals can be time consuming and, as a result, detracts from the user's experience. In addition, because each source has unique methods of locating content, it can be difficult for users to search for content, which can also detract from the user's experience. Moreover, the volume of available information and content that might be of interest can also dissuade users from accessing alternative sources of content and as such the user has a sub-optional experience.

Accordingly, there is a need for systems and methods to provide an access portal to aid a user in finding media across multiple services or libraries. There is also a need for systems and methods to facilitate and streamline the discovery and browsing of media content across multiple disparate online media services. Moreover, it would be beneficial for systems and methods to enable searching for, and discovery of media content across multiple sources without requiring explicit, text based input from a human operator.

These and other considerations are addressed by the present invention.

### BRIEF DESCRIPTION OF THE DRAWINGS

FIG. 1 is a high-level diagram of a system for providing media content in accordance with at least one embodiment disclosed herein;

FIG. 2 is a block diagram of a media server computer system for providing media content in accordance with at least one embodiment disclosed herein;

FIG. 3 is a flow diagram showing a routine for providing media content in accordance with at least one embodiment disclosed herein;

FIG. 4 is a screen shot showing exemplary presentations of related media content in accordance with at least one embodiment disclosed herein;

FIG. 5 is a screen shot showing exemplary presentations of related media content in accordance with at least one embodiment disclosed herein;

FIG. 6 is a screen shot showing exemplary presentations of related media content in accordance with at least one embodiment disclosed herein;

FIG. 7 is a screen shot showing exemplary presentations of related media content in accordance with at least one embodiment disclosed herein;

FIG. 8 is a screen shot showing exemplary presentations of related media content in accordance with at least one embodiment disclosed herein;

FIG. 9 is a screen shot showing exemplary presentations of related media content in accordance with at least one embodiment disclosed herein; and

FIG. 10 is a screen shot showing exemplary presentations of related media content in accordance with at least one embodiment disclosed herein.

### SUMMARY OF THE INVENTION

According to a first aspect, method for selectively providing a user with media content items that are related to a seed content media file (the seed content) is provided. The method includes providing seed content that includes metadata to a user using a networked media output device. The method also includes executing one or more available actions with respective media content libraries and, in response, receiving respective lists identifying media content items that are available from the plurality of media content libraries. The method also includes generating a blended list of media content items from the respective lists of media content items available from the plurality of media content libraries. The step of generating the blended list comprises, for a particular media content item that is identified as being available in at least two of the plurality of media content libraries, selecting the particular media content item from a first media content library as an alternative to the particular media content item that is also available from a second media content library. The selection is based on selection criteria concerning one or more attributes including: cost, quality, availability and the speed of access of the particular media content. The method also includes populating the blended list with a link to the selected particular media content item and one or more other media content items from the respective lists and displaying the blended list of media content items to the user using an associated display device.

According to another aspect, a multi-media server for selectively providing a user with media content items that are related to a seed content media file (the seed content) and which are available from a plurality of media content libraries is provided. The system comprises a non-transitory computer readable storage medium, and a local media content library stored on the storage medium. The sever also includes a processor communicatively coupled to the storage medium and a communication device configured to communicatively couple the processor to a remote media content library over a network connection. The server also includes one or more software modules including instructions in the form of code that are executed by the processor. The software modules include a media output module that configures the processor to provide the seed content, which includes metadata, to the user using a networked media output device. The software modules also include a media processing module that configures the processor to identify one or more available actions that can be performed on respective media content libraries and execute at least one of the one or more available actions based on the metadata. The software modules also include a communication module that configures the processor to receive, in response to executing at least one of the one or more available actions, respective lists identifying media content items that are available from the plurality of media content libraries. In addition, the media processing module further configures the processor to generate a blended list of available media content items from the plurality of media content libraries. Generating the blended list includes, for a particular media content item that is provided by at least two of the plurality of media content libraries, selecting the particular media content item from a first media content library as an alternative to the particular media content item that is also available from a second media content library. The selection is performed based on selection criteria concerning one or more attributes including: cost, quality, availability and speed of access of the particular media content. Moreover, the media processing module further configures the processor to populate the blended list with a link to the selected particular media content item and one or more other media content items from the respective lists. In addition, the media output module further configures the processor to display the blended list of media content items to the user using an associated display device.

These and other aspects, features, and advantages can be appreciated from the accompanying description of certain embodiments of the invention and the accompanying drawing figures and claims.

### DETAILED DESCRIPTION

By way of example only and for the purpose of overview and introduction, embodiments of the present invention are described below which concern systems and methods for automatically providing related media content to users.

The disclosed embodiments relate to an automated system and algorithm that aids in the automatic discovery and presentation of media content, in particular, music content, that is available across multiple online music services. More specifically, the disclosed embodiments utilize the meta-data associated with a given musical title (the “seed content”) being listened to or previously accessed or viewed to find related or similar content, radio stations, or music streams and the like from across multiple online music services (such as iTunes, Rhapsody, Spotify, Pandora, etc.). The system then selects, arranges and presents those actions and results to a user for additional actions, such as browsing, playback, or queuing for future playback.

According to a salient aspect, the systems and methods disclosed herein automatically retrieve the available content and services from disparate content and service providers and provides the user with a single access portal to access the content.

In addition, the exemplary embodiments enable searching for, and discovery of music titles across multiple sources without requiring explicit, text based input from a human operator. According to another aspect, the systems and methods for automatically providing related media content utilize characteristics of the seed content such as genre, album name, track title, artist, mood, tempo, etc., to find more music titles that are similar to the seed content in one or more such attributes.

In some implementations the seed content could be a title of content that is currently playing or being browsed (and/or previously played, browsed and the like) on a device, software application, web site, or similar interface configured to browse and playback or otherwise access music content. Accordingly it can be appreciated that the seed content could also be a title that was identified as a result of a previous search or searches.

As further described herein, the system can include a media server platform that is configured to play digital media, including music, and communicate with remote media distribution servers. Although the exemplary systems and methods further described herein in the context of a media server for delivering digital music content, it can be appreciated that the systems and methods are not so limited and can be effectively employed in any scenario where digital media content is provided to the user and related content is available from third-party content providers, for example, music content, video content, text content, and the like.

The systems and methods for automatically providing related media content are now described more fully with reference to the accompanying drawings, in which one or more illustrated embodiments and/or arrangements of the systems and methods are shown.

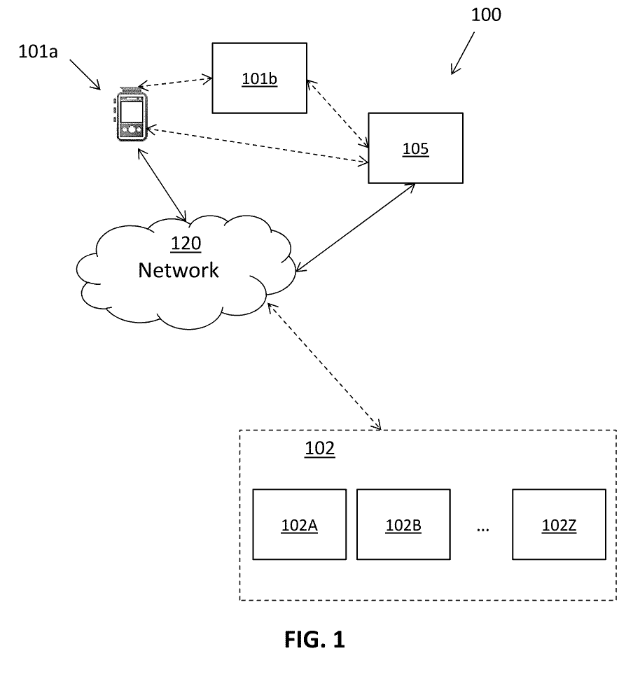

FIG. 1 shows a high-level diagram illustrating an exemplary configuration of a system (100) for providing related digital media content. In one arrangement, the system 100 consists of a media server 105 that is, preferably, in communication with one or more remote media distribution servers 102 (102A, 102B . . . 102Z). As depicted in FIG. 1, in some implementations, the media server 105 can be operatively connected to one or more other electronic devices, for example, input device 101a and media output device 101b.

The user input device 101a can be any mobile computing or electronic devices and/or data processing apparatus capable of embodying the systems and/or methods described herein, and is intended to represent various forms of computing devices that a user can interact with to control the media server and are capable of being in communication with the media server 105, such as a remote control device, personal computer (PC), laptop, tablet computer, personal digital assistant, mobile electronic device, smart phone device and the like.

As would be understood by those in the art, media output device 101b can be practically any electronic device, computing device and/or data processing apparatus capable of being in communication with the media server 105 and outputting digital media content, including without limitation, home-audio systems, home-video systems, audio receivers, televisions, personal computers and the like.

As would be understood by those in the art, the remote media distribution servers 102 can be practically any computing devices and/or data processing apparatuses capable of communicating with the media server 105 receiving, transmitting and storing electronic information and providing media content as further described herein. In some implementations, media distribution server 102 can be operated by one or more media content and service providers that distribute media content to users, such as, Pandora by Pandora Media Inc. of Oakland, Calif., Spotify by Spotify Ltd. of Sweeden, Rhapsody of Seattle Wash., iTunes by Apple Inc. of Cupertino, Calif., and the like.

As would be understood by those skilled in the art, such media distribution servers 102 transmit media content to users through communications networks (120), such as the internet such that users can listen to the media content using personal computing devices. These users can include account holders (e.g., free subscribers, paid subscribers, account holders, etc.) and/or users that do not have accounts. In this manner the media distribution servers can stream media content to practically any networked computing device (e.g., media server 105, user device 101a, media output devices 101b and the like).

The media server 105 can be practically any computing device and/or data processing apparatus capable of communicating with the remote media distribution servers 102 receiving, transmitting and storing electronic information and processing requests as further described herein. For example, media server 105 can include but is not limited to or personal computing devices such as a server computing device, personal computer (PC), laptop, tablet computer, personal digital assistant, mobile electronic device, smart phone device and the like. It should also be understood that the media server and/or remote media distribution servers can also be a number of networked or cloud based computing devices.

It should be noted that while FIG. 1 depicts the system for providing media content 100 with respect to a media server 105, an input device 101a and an output device 101b and remote media distribution servers 102, it should be understood that any number of such devices can interact with the system in the manner described herein. It should also be noted that while FIG. 1 is further discussed herein with respect to a user (not depicted), it should be understood that any number of users can interact with the system 100 in the manner described herein.

It should be further understood that while the various computing devices and machines referenced herein, including but not limited to the media server 105, input device 101a, output device 101b and remote media distribution servers 102 are referred to herein as individual/single or plural devices and/or machines, in certain implementations the referenced devices and machines, and their associated and/or accompanying operations, features, and/or functionalities can be combined or arranged or otherwise employed across any number of devices and/or machines, such as, over a network connection or wired connection, as is known to those of skill in the art.

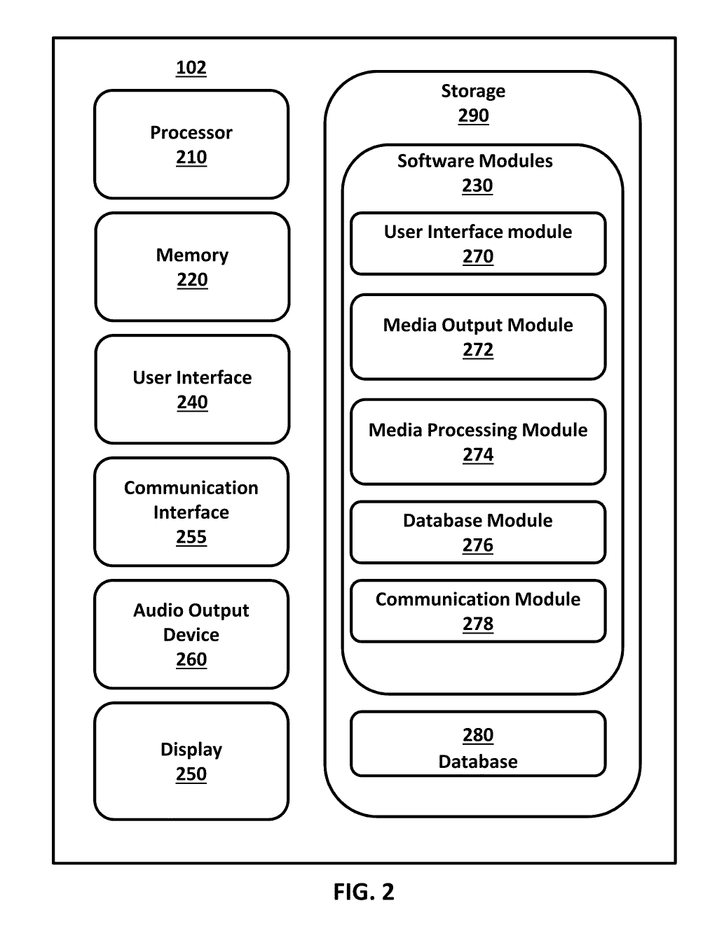

FIG. 2 is a high-level diagram illustrating an exemplary configuration of the media server 105 for use in the system (100) for providing media content. As shown, the media server 105 includes a processor 210, which is operatively connected to various hardware and software components that serve to enable operation of the systems and methods described herein. The processor 210 serves to execute instructions to perform various operations relating to playing digital media content and providing related digital media content as will be described in greater detail below. The processor 210 can be a number of processors, a multi-processor core, or some other type of processor, depending on the particular implementation.

In certain implementations, a memory 220 and/or a storage medium 290 are accessible by the processor 210, thereby enabling the processor 210 to receive and execute instructions stored on the memory 220 and/or on the storage 290. The memory 220 can be, for example, a random access memory (RAM) or any other suitable volatile or non-volatile computer readable storage medium. In addition, the memory 220 can be fixed or removable.

The storage 290 can take various forms, depending on the particular implementation. For example, the storage 290 can contain one or more components or devices such as a hard drive, a flash memory, a rewritable optical disk, a rewritable magnetic tape, or some combination of the above. The storage 290 also can be fixed or removable and can also be local to the media server 105 or remote, for example, a cloud based storage device, or any combination of the foregoing.

One or more software modules 230 are encoded in the storage 290 and/or in the memory 220. The software modules 230 can comprise one or more software programs or applications having computer program code or a set of instructions executed in the processor 210. Preferably, included among the software modules 230 is: a user interface module 270 that configures the system to receive user inputs from an associated user interface 240; a media output module 272 that configures the system to output media content and related information via associated output devices (e.g., user interface 240, audio output device 260, display 250); a media processing module 274 that configures the system to retrieve, process and output related digital media content as further described herein; a database module 276 that configures the processor to store information concerning the operation of the systems and methods described herein; and a communication module 278 that configures the processor to communicate with one or more remote computing devices.

Such computer program code or instructions for carrying out operations or aspects of the systems and methods disclosed herein can be written in any combination of one or more programming languages, as would be understood by those skilled in the art. The program code can execute entirely on the media server 105 as a stand-alone software package, partly on the media server 105 and partly on one or more remote computing devices, such as, a user input device 101a and media output devices 101b, or entirely on such remote computing devices. In the latter scenario, the various computing devices can be connected to the media server 105 through any type of wired or wireless network, including a local area network (LAN) or a wide area network (WAN), or the connection can be made to an external computer (for example, through the Internet using an Internet Service Provider). It should be understood that in some illustrative embodiments, one or more of the software modules 230 can be downloaded over a network to the storage 290 from another device or system via the communication interface 255. For instance, program code stored in a computer readable storage device in a server can be downloaded over a network from the server to the storage 290.

Also preferably stored on the storage 290 is a database 280. As will be described in greater detail below, database 280 contains and/or maintains various data items and elements that are utilized throughout the various operations of the system (100) for providing media content. For example, the database can contain include user information including account information concerning the user's various accounts with third-party media content and service providers. The database can also include user preferences concerning operation of the system 100 and other settings related to the third-party media content and service providers. By way of further example, the database can also include a library of digital media content, for example, a user's personal library of digital media files (e.g., music files, video files, text files, web content and the like) in various digital formats as would be understood by those in the art. It should be noted that although the database 280 is depicted as being configured locally to the media server 105, in certain implementations the database 280 and/or various of the data elements stored therein can be stored on a computer readable memory or storage medium, which is located remotely and connected to the media server 105 through a network (not shown), in a manner known to those of ordinary skill in the art.

A user interface 240 (e.g., user input device 101a in FIG. 1) is also operatively connected to the processor 210. The interface can be one or more input device(s), such as switch(es), button(s), key(s), a touch-screen, as would be understood in the art of electronic computing devices. Interface serves to facilitate the capture of commands from the user. For example, the interface can capture information or commands from the user concerning the media content being played, user information and third-party information and preferences related to the operation of the system for providing media content 100, as further described herein.

A display 250 (e.g., user input device 101a, output device 101b in FIG. 1) can also be operatively connected to the processor 210. The display 250 includes a screen or any other such presentation device that enables the system to instruct or otherwise provide feedback to the user regarding the operation of the system (100) for providing media content. By way of example, display 250 can be a digital display such as an LCD display, a CRT, an LED display, or other such 2-dimensional display as would be understood by those skilled in the art.

By way of further example, the user interface 240 and the display 250 can be integrated into a touch screen display. Accordingly, the display is also used to show a graphical user interface, which can display various data and provide “forms” that include fields that allow for the entry of information by the user of the media server 105. Touching the touch screen at locations corresponding to the display of a graphical user interface allows the user to interact with the device to enter data, control functions, etc. So when the touch screen is touched, interface communicates this change to processor, and settings can be changed or user entered information can be captured and stored in the memory.

One or more audio output devices 260 (e.g., output device 101b in FIG. 1) can be operatively connected to the processor 210. The audio output device 260 serves to facilitate the playing of media content having an audio component and/or visual component and the like as would be understood by those in the art.

A communication interface 255 is also operatively connected to the processor 210. The communication interface 255 can be any interface that enables communication between the media server 105 and external devices, machines and/or elements (e.g., input device 101a, output device 101b and media distributions servers 102 in FIG. 1). In certain implementations, the communication interface 255 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the media server 105 to other computing devices and/or communication networks, such as private networks and the Internet. Such connections can include a wired connection or a wireless connection (e.g., using the IEEE 802.11 standard known in the relevant art) though it should be understood that communication interface 255 can be practically any interface that enables communication to/from the processor 210.

At various points during the operation of the systems and methods disclosed herein, the media server 105 can communicate, directly or indirectly, with one or more of the remote computing devices, such as, input device 101a, output device 101b and media distributions servers 102 in FIG. 1.

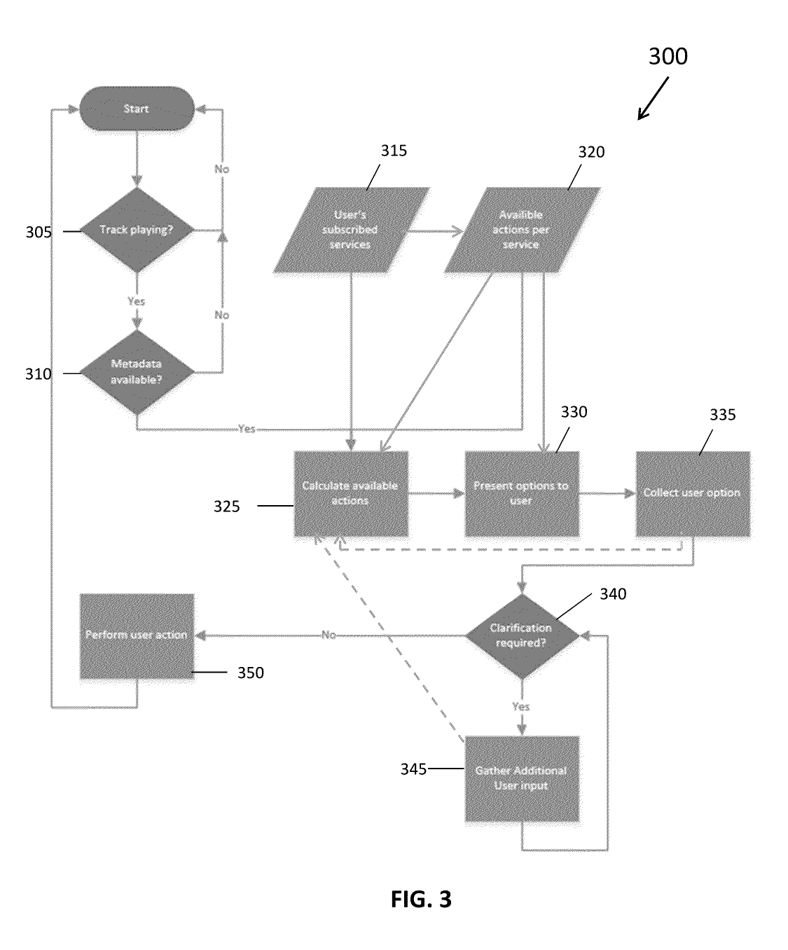

The operation of the exemplary system (100) for providing media content described above will be further appreciated with reference to the method for providing media content described below, in conjunction with FIG. 3 and FIGS. 4-10.

It should be appreciated that several of the logical operations described herein are implemented (1) as a sequence of computer implemented acts or program modules running on the various devices of the system 100 and/or (2) as interconnected machine logic circuits or circuit modules within the system (100). The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Turning now to FIG. 3, a flow diagram illustrates a routine 300 for providing media content in accordance with at least one embodiment disclosed herein. The process begins at step 305, where the processor 210, configured by executing one or more of software modules 230, including, preferably, the media output module 272, the media processing module 274 and the database module 276, identifies the seed content to be used for identifying related content items as further described herein. For example, in some implementations the configured processor can determine whether media content is currently being played via the media server 105 and the currently playing track can be used as the seed content. In addition or alternatively, the seed content can be one or more tracks that were previously played by the media server or that are queued for future playback, for example, as identified from a history maintained by the media server 105 and stored in the database 280. By way of further example, the seed content can be one or more artists, albums, tracks and other such attributes associated with content that the user is browsing using the media server 105.

Then at step 310, the configured media server processor can determine whether metadata relating to the seed content is available from the seed content. For example, in some implementations, the processor can accept, as an input, a digital music file and can examine the digital file for metadata “tags”, including for example, album name, artist name, track title, genre, mood, tempo and other such attributes assigned to digital media content, as would be understood by those skilled in the art. In some implementations, the configured processor can directly receive the metadata of the current song being output by the media server 105. As an example, the seed content can contain the following metadata fields and associated metadata tags (as represented in the format FIELD:TAG), TITLE: COME TOGETHER; ALBUM: LOVE; ARTIST: THE BEATLES. The configured processor can also store the metadata in the memory 230 or the storage 290 so as to generate a history or “catalog” of media content, played, queued, searched, browsed or accessed from any local or networked media content source using the media server 105. As further described herein, the configured processor can use the available metadata to identify related content and present the related content options to a user.

At step 315, the processor 210 of the media server 105, which is configured by executing one or more of software modules 230, including, preferably, the media output module 272, the media processing module 274 and the database module 276, identifies the various sources of media content that are available to the user. For example, the various sources of media content can include local storage, networked storage devices and third-party media content and service providers.

Once the available metadata fields have been identified from the seed content and cataloged, at step 320, the media server can identify the possible metadata inputs that can be used to search the various local and remote media content sources. In some implementations, the processor 210 of the media server 105, which is configured by executing one or more of the software modules 230, including, preferably, the media processing module 274, the database module 276, and the communications module 278, determines the available actions that can be performed using local media content sources and remote content sources such as the third-party media content and service providers. Available actions can include the various types of searches for related content that can be performed using the various media sources. This can be determined from a list or matrix of available actions and accepted metadata inputs, as dictated by respective media content sources. For example, the list/matrix or other such rules can indicate that the media content source maintained by a particular third-party media content and service provider is searchable by artist name, song title and album title, whereas, another media content provider is also searchable by metadata that relates to music genre and tempo. By way of further example, the matrix of available actions can also identify the services performed by respective media content sources, such as, purchase media content, stream media content, start a custom radio station, view information concerning media content, and the like, as would be understood by those in the art.

As would be understood by those skilled in the art, many of the third-party media content and service providers operate media distribution servers (e.g., 102) that are configured to transmit media content through the internet to computing devices associated with users who are account holders (e.g., free subscribers, paid subscribers and the like) and/or users that do not have accounts. In this manner the media distribution servers can transmit media content to the various computing devices connected thereto (e.g., media server 105, user device 101a, media output devices 101b) via web interfaces and APIs. It can also be appreciated that the various actions and services that can be provided by such media sources can vary from one user to another depending on the subscriptions/accounts that the user possesses. For example, a media distribution server 102 can be configured to offer a unique set of options/services to paid subscribers as compared to the services that it provides to non-paying subscribers. Accordingly, the configured processor 210 can determine the available actions based on the accounts that a user has with the various third party content distribution services. For example, the configured processer can first query the database 280, storage 290 and/or memory 230 containing the user's account information to identify third-party services the user has an account/subscription with and to obtain the user's respective account information.

In some implementations, the processor can cross-reference the metadata fields of the seed content with the available actions to generate a matrix of available actions based on the seed content. Based on the intersections of the metadata fields, and the metadata inputs that are useable to search the various media content sources, the processor configured by the media processing module 274 can generate a catalog of the various actions that can be performed to find content across the plurality of media content sources. As described in relation to step 330, the catalog of options can be presented to the user via the display.

In addition or alternatively, the configured processor 210 can systematically query the media content and service providers via an API to respective remote media distribution servers 102 to determine the available actions per service based on the seed content metadata fields. Responsive to the queries, the system server 105 can receive from each respective media distribution server 102, a list of available actions that are supported by the media distribution servers. For example, in response to the query, the Pandora service might provide that, given a particular user subscription level and the metadata fields (e.g., title, artist and album fields), the available actions are to, say, launch a radio station by the name of the artist, song or album. By way of further example, different actions might be supported by the iTunes service, say, purchase an album by track name or artist name.

It can be appreciated that the available actions can be determined regardless of the source of the seed content. For example, the seed content currently playing can be associated with music content that is stored locally in the database 280 (e.g., from the user's personal library of songs) or a track streaming from a remote media distribution server 102 and the like. Moreover, it can also be appreciated that the available actions are not limited to those provided by third-party media content providers and services and that the media server 105 can also determine whether it can perform any actions locally based on the seed content playing. For example, based on a seed content having the following metadata tags Title: Come Together; Album: Love; Artist: The Beatles, the configured processor 210 can query the database to determine whether any additional content (e.g., music or videos tracks and the like) that relate to “The Beatles,” “Love” or “Come Together” are stored locally on the database 280 and available for playback to the user.

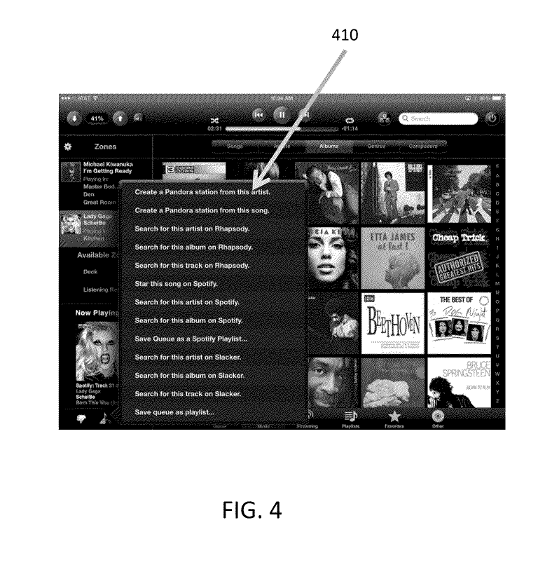

In addition or alternatively to step 320, at step 325, the media server 105 can determine the available actions based on the specific metadata tags that are associated with the seed content (e.g., the actual song title, actual artist name, etc.). Accordingly, the media server 105 can identify the additional content that is available for a particular seed content item with specificity. More specifically, the processor 210 of the media server 105, which is configured by executing one or more of the software modules 230, including, preferably, the media output module 272, the media processing module 274, processes the determined actions through each of the available media content sources based on the actual metadata tags associated with the seed content. For example, the configured processor 210 can communicate with the respective remote media distribution servers 102 and/or local sources to systematically execute the available actions identified at step 320 using the metadata tags associated with the seed content and optionally the user account information. The information received from the various media content sources can be stored, output or otherwise presented to the user as further described in relation to step 330 and FIGS. 4-10.

In some implementations, the processor 210 of the media server, which is configured by executing the software modules 130, for example, the media processing module 274 (e.g., the a rules engine) can be configured to perform a continuous or periodically recurring calculation of the available actions and execute those actions based upon the seed content, say, currently playing content, previously played/browsed media content, queued media content or content that is projected to be of interest to the user. In this manner the system can determine what the available actions are and also retrieve the results of executing those actions and related information in advance of receiving any input from the user. In this manner, the execution of the available actions allows the media server to have the result of executing the available actions queued for output to the user without the delay that might occur if the system were to only execute a user's input in an on demand fashion. Moreover, the system can augment or tailor the presentation of the available actions with supplemental content and information received from the various media sources, as further described in relation to FIGS. 4-9.

Then at step 330, the available actions determined at steps 320 and/or 325 are presented to the user. In some implementations, the processor 210 of the media server 105, which is configured by executing one or more of the software modules 230, including, preferably, the media output module 272, and the media processing module 274, outputs the available actions and prompts the user to select the one or more of the available actions.

In some implementations, the configured processor can display one or more prompts on the display 250 notifying the user that content that is related to the currently playing track is available. For example, a virtual button “Explore Related Content” can be displayed. By way of further example, the user can be presented with branching options to focus the search for related content to a particular content source or online service, and/or focus the available actions to particular metadata field. In addition or alternatively, a more complete list of the options (as an example) could be presented to the user as well as supplemental information concerning the seed content. In some implementations, the available actions, media content items and/or supplemental information concerning the related media content that is available from the one or more media content sources can be presented to the user in a variety of arrangements, for example as described herein and in relation to FIGS. 4-10.

In some implementations, the list of actions and additional information that are presented to the user can be generated and assembled based on contextual information that is derived from a history of the user's previous actions using the media server 105. For example, if the user is browsing music by artist, the configured processor can search the multiple music services for songs or albums by that artist (e.g., at step 325) for presentation of the results as a blended list of albums and/or song titles (e.g., media content) as further described in relation to FIGS. 4-9.

Then at step 335, the processor 210 of the media server 105, which is configured by executing one or more of the software modules 230, including, preferably, the user interface module 270, the media output module 272, and the media processing module 274, receives a user selection via the user interface 240 (e.g., user input device 101a of FIG. 1). For example, the user can click or interact with one or more of the virtual buttons presented at step 330 and once the user makes a selection of one of these options, the configured processor 210, using the user interface 240, receives this selection and can execute the corresponding instruction.

At step 350, the processor the processor 210 of the media server 105, which is configured by executing one or more of the software modules 230, including, preferably, the user interface module 270, the media output module 272, and the media processing module 274, executes one or more of the available actions. The available actions can be executed automatically or in response to a user input. For example, if the input is a command to invoke a particular action by a particular media content source, the selected action can be performed via one or more API call(s) to an online media content source. In some implementations, the configured processor can determine how to interact with the different online sources, via their API. It can be appreciated that the third party media content and service providers each provide their own web-based API for communicating with respective media content distribution servers 102. These vary in feature set and complexity and the media server abstracts these differences away to automatically perform that selected task on behalf of the user.

For example, when the user selects an action, the metadata tags are utilized to interact with the selected media service based on the users indicated intent. In other words, if “Create a Pandora station from this artist was selected”, the artist of the currently playing track can be submitted to the Pandora music service as a seed, and instructions are executed between the media server and the Pandora music service to create a new custom radio station based on that artist and is played by the media server and output. In addition or alternatively, a user's input in response to the available actions can cause the configured processor 210 to generate and/or present a further refined list of available actions, for example, as described in relation to steps 320-330.

In some cases, clarification can be required to complete the requested actions (step 340). One example would be to clarify the exact Artist of interest, say, “Paul McCarthy” OR “Paul McCarthy and Wings.” A need for such clarifying input can occur when an API call from the media server 105 based on the currently available information, (e.g., user input received at step 335 and/or the metadata collected at step 310 and/or the available actions calculated at 325) results in an error message that is received from a content source. Alternatively, such errors can be generated automatically by the media server. Accordingly, at step 345, the configured processor can display a prompt for additional user input and receive the user input via the user interface and, based on that input, refine the determination of available actions or re-execute the action accordingly.

The exemplary embodiments, arrangements and implementations of the systems and methods for providing related digital content 100 are further described in relation to FIGS. 4-10. FIGS. 4-10 are screen shots depicting exemplary presentations and arrangements of available actions, the seed content and supplemental information by the media server 105.

In some implementations, when a seed song is being accessed (e.g., a locally stored song being played), an inventory of the available and subscribed music services is assembled and stored in memory by the media server 105. In addition, the album, artist, title, genre, mood, and other metadata attributes of the currently playing seed can be examined and stored in memory. In addition, available actions can be computed by the media server using the matrix of metadata and music services and presented to the user. As shown in FIG. 4, for example, this list of available actions 410 containing items such as “Search for this artist on [service x]” or “Create a radio station based on this song on [service y]” is presented to the user. In addition, the media server can utilize the metadata to perform one or more searches with the various media services. As noted above, such searches can be performed in response to the users input or automatically.

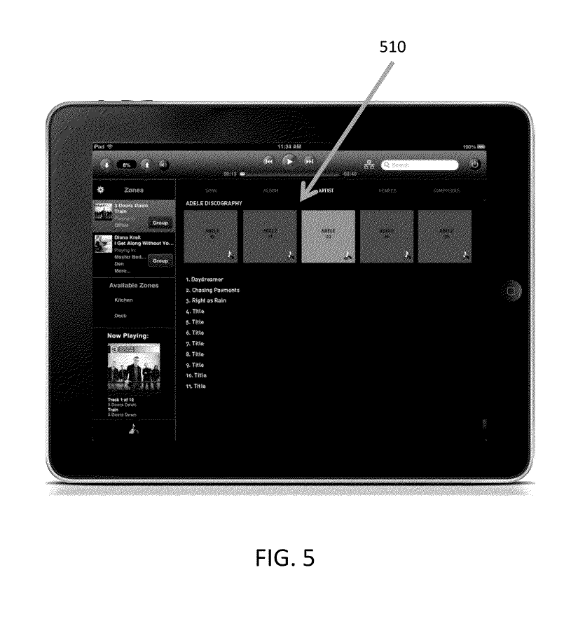

In some implementations, while browsing a particular artist's music content, the available actions displayed by the media server can include a blended view of the artist's entire discography 510 (e.g., all albums/tracks and other such media content items) assembled from various media sources, as shown in FIG. 5. More specifically, the media server 105 using the processor 210, can assemble a discography by querying one or more of the media sources for a listing of the tracks in the discography. In addition, the media server can query the media sources to identify whether the various tracks in the discography are available locally or through one or more free and/or paid online media content and service providers. The media server can also compile all the available content or sources of the available content into a single discography for presentation to the user. In this manner, the user can be provided more complete access to an artist's body of work, and can select individual or groups of songs and albums to listen to without having to individually purchase and/or store every title.

According to a salient aspect, the media server is configured to display a blended view of related media content so as to provide a single portal for the user to view and access a more complete set of related media content, even when the various individual media sources have differing or incomplete offerings of related content to draw from. In addition, the available actions/media content presented can be selected from the various sources, prioritized or ranked according to a variety of criteria so as to provide an optimized user experience even across multiple sources of media content. For example and without limitation, the selection criteria can concern the speed of access (e.g., bandwidth, latency of delivery, etc.), quality of the media content (e.g., fidelity, accuracy, completeness, popularity, etc.), cost of the media content (e.g., free, subscription based, pay-to-play, pay-to-own, etc.), availability (e.g., how long the content is available, where it will be stored, what sources provide certain types of content, etc.) and the like. Selection criteria can also include content type (e.g., sound, text, video, etc.) and user preferences concerning the foregoing criteria (e.g. preferred media format, media type, media source, etc.) which can be expressly input by the user or automatically identified by the media server through the analysis of the historical actions and interests of one or more users.

The media server can be configured to generate a blended presentation of media content and related information from across multiple various sources by selectively querying the available sources, analyzing the available media content as a function of the selection criteria, content types and preferences which serve to inform the selective retrieval and presentation of media content from across the various sources of media content.

For example, generating such a blended presentation can include identifying the types of content items that are to be presented to the user. The types of content items to be displayed can vary as a function of the available actions/information to be displayed and an associated presentation format (e.g., artist discography, album, track information). For example, when displaying an artist discography, the media server can be configured to display content items, such as, album names, track names, album cover art and the like. Preferably at least some of the content items can be identified with actionable links to respective content items which are also associated with a content source (e.g., links to play/buy/consume/queue each content item). The types of content items to display can also be dictated by formatting standards stored by the media server as well as user preferences.

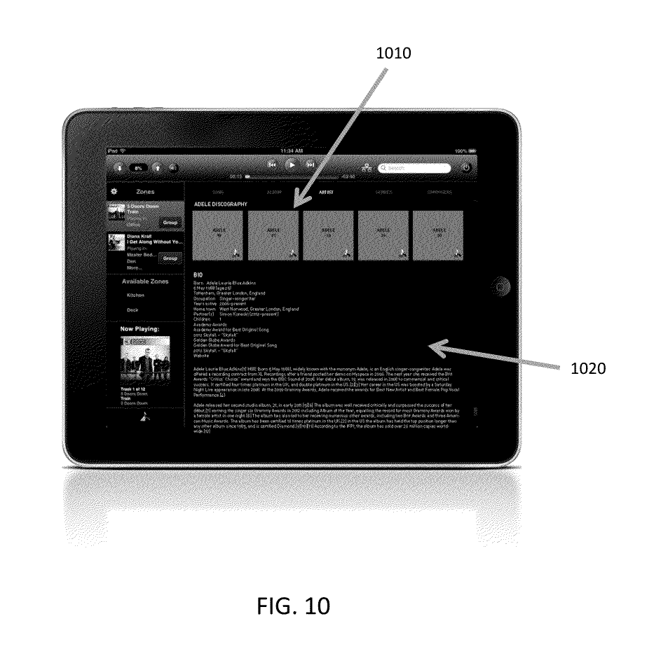

The media server can also be configured to identify a set of content items to be presented to the user based on the identified types of media content to be provided and the seed content. The set of content items can be determined by querying the various media content sources using seed content metadata attribute(s) and selectively combining the information received from one or more of the content sources so as to provide a more complete and accurate listing of content items for presentation. More specifically, the information returned by the various media content sources can be analyzed or compared and the set of content items can be identified based on the selection criteria for example, how relevant, complete, accurate or how reliable the information returned by a particular content source is to the seed content and type of content item to be displayed. For example, when assembling a discography for a particular artist, the identified content items can include the list of album titles, track titles, artist information, cover art and the like. Moreover, by analyzing the query results according to the selection criteria, the configured media server might identify that Rhapsody provides the most complete listing of all studio albums, whereas additional listings of albums are available from another source, say, Spotify. By way of further example, configured media server can identify additional media content and information that is useable to augment the discography is available from one or more other media sources (e.g., cover art, biographical information, album reviews and the like). For example, as shown in FIG. 10, the artist's discography 1010 can be further supplemented by the media server with biographical information 1020 about the artist that is gathered from one or more of the available services.

In some implementations, particularly when the identified content items are of the type that are actionable using the media server (e.g., played/queued/viewed/purchased and the like), the media server can be configured to select the most appropriate content item or link to the most appropriate source for the content item. More specifically, the media server can be configured to compare and rank the content items or sources according to one or more of the selection criteria, in particular, when the same content item is available from multiple sources. In this manner, the selection criteria can be applied to the content items and competing interests can be weighed so as to identify and select the most appropriate content items or prioritize the available content items. For example, large digital media content items might be selected from local storage as opposed to remote content sources that stream the media because a higher speed of delivery can be achieved. By way of further example, higher quality media content items might be preferred over lower fidelity versions. By way of further example, media content can be ranked in terms of cost to access, say, free media sources are preferred over subscriber media sources which are preferred over pay to download/play sources. By way of further example, media content can be selected as a function of playback constraints, say, current bandwidth requirements and/or limitations associated with the local network or with the various content sources. As noted above, content item selection can also be determined based on how long content will be available (e.g., download and keep indefinitely, stream on demand, etc.), content type (e.g., sound, text, video, etc.) and user preferences that relate to any of the foregoing criteria. Moreover, content selection and presentation can be continuously updated based on user and system feedback, changing preferences and as additional content and information becomes available from the various sources. In this manner, the selection or presentation of media content can be dynamically updated as the conditions change in real-time or in near-real time so as to adapt, augment and optimize the user experience accordingly.

As previously noted and further described herein, the media server can also be configured to assemble the identified content items (e.g., identifiers, associated links and any additional information) for presentation to the user.

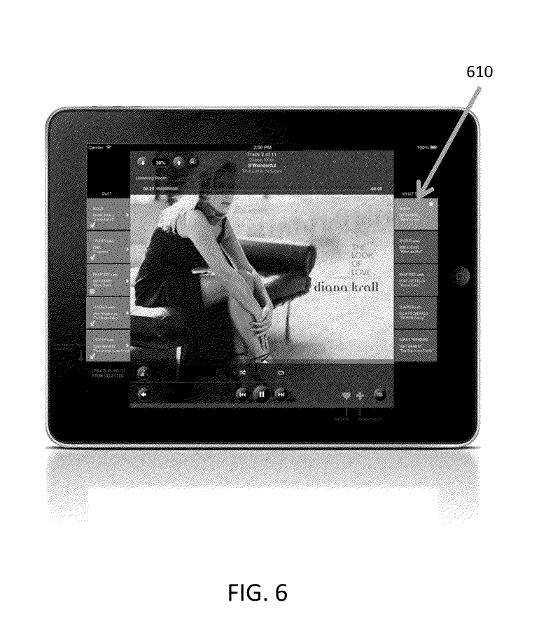

In some implementations, for example, as shown in FIG. 6, while listening to a particular title, the media server 105 can be configured to present the user with a list 610 of past songs and/or queued songs. Each of the songs in the list can be selected by the user or otherwise utilized by the media server as seed content to perform a blended search for related content in accordance with the disclosed embodiments. In this manner, the available actions and information can be supplemented by the media server based on seed content that is not currently playing, yet is related to and/or relevant to the user's interaction with the media server 105.

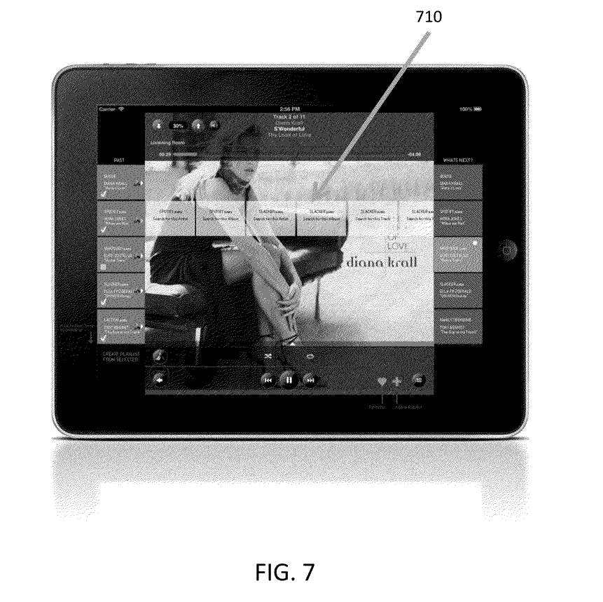

In some implementations, when seed content is played, accessed or otherwise selected, the media server 105 can be configured to present the user with a list of actions which will allow the discovery of similar music focused by metadata field (album artist, track) and/or by media source (e.g., spotify, slacker, etc.). For example, as shown in FIG. 7, the displayed list of available actions 710 may contain items such as “Search for this artist on [service x]” or “Create a radio station based on this song on [service y]”. When the user selects an action, the stored metadata information can be utilized by the media server 105 to perform the particular action (e.g., search) on the selected media service based on the users indicated intent. In other words, if “Search Spotify for this artist” was selected, the artist metadata of the currently playing track can be submitted to the Spotify music service as an input, and instructions are executed by the media server 105 to receive and access the artists music from the content provider.

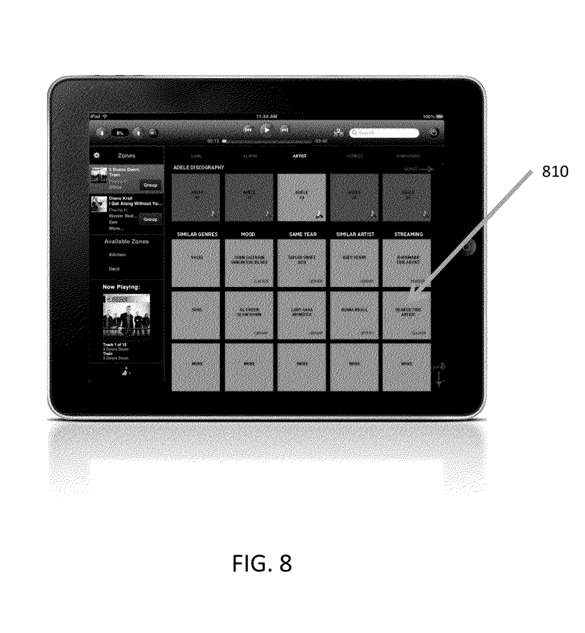

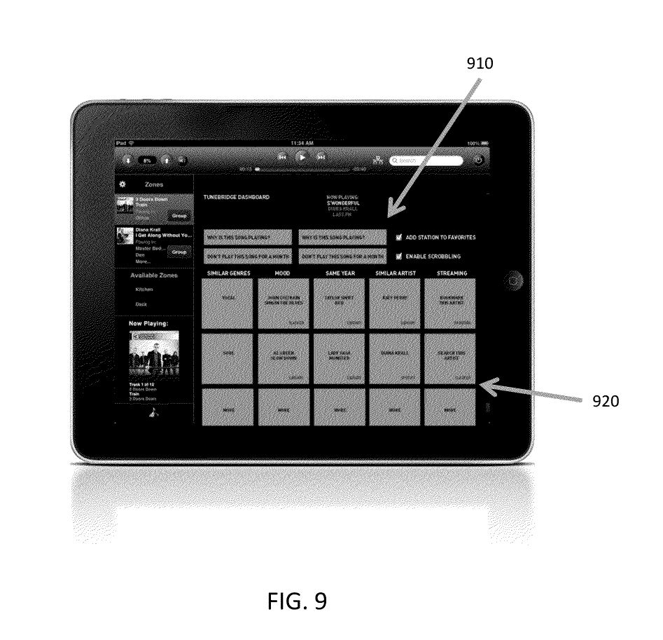

In some implementations, for example, as shown in FIG. 8, the media server can present the user with a list of available actions 810 that allow for the discovery of music having similar attributes and that are available across the various media content sources. The available actions that are presented can include specific content items that are available from the various sources or actions that can be performed by the content sources (e.g., further queries). For example, when seed content is being accessed (e.g., an artist's discography is being viewed, a song is being played or selected and the like), metadata of the selected title (e.g., the album, artist, title, genre, mood, and such other attributes) can be analyzed and stored in memory by the media server. An inventory of the available and subscribed music services can also be assembled and stored in memory as well. The value of each metadata attribute can also be used by the media server to search the available content sources. The information and content returned by the various content sources can be compiled and displayed together in a categorized list. For example, as shown in FIG. 8, the information received can be arranged into columns. As previously noted, the content, information and actions that are displayed can be arranged or compiled in accordance with contextual information associated with the user, say, a history of the content consumed by the user or the user's interests. Moreover, as shown in FIG. 9, the media server can be configured to present a dashboard 910 along with the arrangement of search results 920. Such a dashboard can provide additional information and queries to allow the operator to better understand why the current title is being played, or why the content items are being recommended by the media server and the like.

At this juncture, it should be noted that although much of the foregoing description has been directed to systems and methods for automatically providing related music content and information concerning the music content, the systems and methods disclosed herein can be similarly deployed and/or implemented in scenarios, situations, and settings far beyond the referenced scenarios. It can be readily appreciated that system 100 can be effectively employed in practically any scenario where electronic media content not limited to music is provided to a user (e.g., music, video, text, multi-media content and the like), and it is desirable to, based on metadata associated with the media content, identify and present related content and information that is available from one or more third party content providers. It can be also appreciated that the arrangement of computing devices and processing steps can vary according to the particular types of third-party content providers/services that are available, as would be understood by those skilled in the art.

It is to be understood that like numerals in the drawings represent like elements through the several figures, and that not all components and/or steps described and illustrated with reference to the figures are required for all embodiments or arrangements. Thus, illustrative embodiments and arrangements of the present systems and methods provide a computer implemented method, computer system, and computer program product for facilitating the automatic transmission of an electronic receipt to a user conducting a financial transaction at a computing device. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed:

1. A computer-implemented method for selectively providing a user with media content items that are related to a seed content media file (the seed content), the method comprising:
providing, with a processor executing code, the seed content to the user using a networked media output device, wherein the seed content includes metadata;
executing, with the processor, one or more available actions with respective media content libraries among a plurality of media content libraries;
receiving, with the processor in response to executing the one or more available actions, respective lists identifying media content items that are available from the plurality of media content libraries;
generating, with the processor, a blended list of media content items from the respective lists of media content items available from the plurality of media content libraries, wherein the generating step comprises, for a particular media content item that is identified as being available in at least two of the plurality of media content libraries:
selecting the particular media content item from a first media content library as an alternative to the particular media content item that is also available from a second media content library, wherein the selection is based on selection criteria concerning one or more of the following attributes: cost, quality, availability and speed of access of the particular media content;
populating the blended list with a link to the selected particular media content item and one or more other media content items from the respective lists;
displaying, with the processor using an associated display device, the blended list of media content items to the user.

2. The method of claim 1, wherein selecting the particular media content item further comprises:
determining, with the processor based on the respective lists, that the particular media content item is available from the first media content library and the second media content library;
comparing an attribute of the particular media content item that is available from the first media content library with a corresponding attribute of the particular media content item that is available from the second media content library; and
selecting the particular media content item that is available from the first media content library based on the comparison and in view of one or more selection criterion.

3. The method of claim 2, wherein the speed of access attribute includes one or more of:
size, bandwidth and latency of delivery.

4. The method of claim 3, wherein the quality attribute includes one or more of: fidelity, accuracy, completeness and popularity.

5. The method of claim 4, wherein the availability attribute includes one or more of: how long the content is available and a location at which the particular media content item is stored.

6. The method of claim 2, wherein the selection criteria includes one or more user preferences.

7. The method of claim 6, further comprising, automatically identifying the one or more user preferences by analyzing one or more user interactions that were previously received by the processor.

8. The method of claim 1, further comprising: identifying, with the processor for each of the plurality of media content libraries based on the metadata and user subscription information, the one or more available actions that can be executed by the processor with the respective media content libraries.

9. The method of claim 1, wherein the plurality of media content libraries include a local media content library stored on a storage medium that is directly accessible to the processor and a remote media content library that is accessible to the processor via a remote media content server.

10. The method of claim 9, wherein executing the one or more available actions further comprises: transmitting, over a network to the remote respective media content library, an API call that includes the metadata and any user subscription information, wherein the user subscription information is stored in the storage medium and is associated with the remote media content library.

11. The method of claim 1, further comprising: ranking one or more of the media content items identified in the respective lists at least in part, in view of the selection criteria.

12. The method of claim 11, wherein the blended list is populated based on the ranking of the media content items in the respective lists.

13. A multi-media server for selectively providing a user with media content items that are related to a seed content media file (the seed content) and which are available from a plurality of media content libraries, the system comprising:
a non-transitory computer readable storage medium;
a local media content library among the plurality of media content libraries, the local media content library being stored on the storage medium;
a processor communicatively coupled to the storage medium;
a communication device configured to communicatively couple, over a network connection, the processor to a remote media content library among the plurality of media content libraries;
one or more software modules including instructions in the form of code executed by the processor, the software modules including;
a media output module that configures the processor to provide the seed content to the user using a networked media output device, wherein the seed content includes metadata;
a media processing module that configures the processor to identify one or more available actions that can be performed on respective media content libraries among the plurality of media content libraries and execute at least one of the one or more available actions on the respective media content libraries based on the metadata;
a communication module that configures the processor to receive, in response to executing at least one of the one or more available actions, respective lists identifying media content items that are available from the plurality of media content libraries,
wherein the media processing module further configures the processor to generate a blended list of available media content items from the plurality of media content libraries, wherein the blended list is generated for a particular media content item that is provided by at least two of the plurality of media content libraries by:
selecting the particular media content item from a first media content library as an alternative to the particular media content item that is also available from a second media content library, wherein the selection is based on selection criteria concerning one or more of the following attributes: cost, quality, availability and speed of access of the particular media content, and
populating the blended list with a link to the selected particular media content item and one or more other media content items from the respective lists, wherein the media output module further configures the processor to display the blended list of media content items to the user using an associated display device.

14. The system of claim 13, wherein the processor is configured to select the media content item by:
determining that the particular media content item is available from the first media content library and the second media content library;
comparing an attribute of the particular media content item that is available from the first media content library with a corresponding attribute of the particular media content item that is available from the second media content library; and
select the particular media content item that is available from the first media content library based on the comparison and in view one or more selection criterion.

15. The system of claim 14, wherein the speed of access attribute includes one or more of: size, bandwidth and latency of delivery.

16. The system of claim 14, wherein the quality attribute includes one or more of:
fidelity, accuracy, completeness and popularity.

17. The system of claim 14, wherein the availability attribute includes one or more of:
how long the content is available and a location at which the particular media content item is stored.

18. The system of claim 14, wherein the selection criteria include one or more user preferences.

19. The system of claim 14, wherein the media processing module further configures the processor to rank one or more of the media content items identified in the respective lists according to the one or more selection criterion and populate the blended list based on the rank of the one or more of the media content items.
